(19) United States
(12) Patent Application Publication
(10) Pub. No.: US 2014/0106238 A1
(43) Pub. Date: Apr. 17, 2014

(54) LIQUID ELECTROLYTE FOR A LITHIUM BATTERY, CONTAINING A QUATERNARY MIXTURE OF NON-AQUEOUS ORGANIC SOLVENTS

(71) Applicants: Nelly Giroud, Saint Etienne (FR); Hélène Rouault, Le Versoud (FR); Florence Rouillon, Villard-de-Lans (FR)

(72) Inventors: Nelly Giroud, Saint Etienne (FR); Hélène Rouault, Le Versoud (FR); Florence Rouillon, Villard-de-Lans (FR)

(73) Assignee: COMMISSARIAT A L'ENERGIE ATOMIQUE ET AUX ENERGIES ALTERNATIVES, Paris (FR)

(21) Appl. No.: 14/123,619

(22) PCT Filed: Jun. 13, 2012
(86) PCT No.: PCT/FR2012/000241

§ 371 Date: Dec. 3, 2013

(30) Foreign Application Priority Data
Jun. 14, 2011 (FR) 1101813

(51) Int. Cl. H01M 10/056

(52) U.S. Cl. CPC H01M 10/056
USPC 429/332

(57) ABSTRACT

A liquid electrolyte for a lithium battery including lithium perchlorate (LiClO₄) dissolved in a quaternary mixture of ethylene carbonate (EC), diethyl carbonate (DEC), tetrahydrofurane (THF) and ethyl methyl carbonate (EMC). The liquid electrolyte advantageously contains between: 10% and 30% by mass of ethylene carbonate (EC), 10% and 30% by mass of diethyl carbonate (DEC), 10% and 30% by mass of tetrahydrofurane (THF) and, 10% and 70% by mass of ethyl methyl carbonate (EMC). The quaternary mixture is preferably a EC/DEC/THF/EMC mixture in a 1/1/1/3 mass ratio. The liquid electrolyte is particularly suitable for use in a lithium battery.

### BACKGROUND OF THE INVENTION

The invention relates to a liquid electrolyte for a lithium battery comprising a lithium salt dissolved in a quaternary mixture of non-aqueous organic solvents.

### STATE OF THE ART

In general manner, the technical field of the invention can be defined as that of formulation of electrolytes, and more precisely as that of formulation of liquid electrolytes, i.e. solutions comprising a liquid solvent and a solute such as a conducting salt, where ionic conduction mechanisms are involved.

Lithium batteries are generally formed by an electrochemical cell or a stack of electrochemical cells in a packaging. Each electrochemical cell is formed by a positive electrode and a negative electrode separated by an electrolyte.

Two sorts of lithium batteries exist:
the primary battery or metal lithium battery in which the negative electrode is composed of metallic lithium and
the secondary battery in which the lithium remains in ionic state and which operates on the principle of insertion or extraction (or intercalation-deintercalation) of lithium in the active material of the positive electrode and of the negative electrode.

Lithium batteries conventionally comprise current collectors ensuring flow of electrons, and therefore electronic conduction, in the external circuit of the lithium battery.

Conventional lithium batteries further comprise a separator impregnated by the liquid electrolyte arranged between the positive and negative electrodes. The separator prevents any short-circuiting by preventing the positive electrode from coming into contact with the negative electrode.

The electrolytes used in current lithium batteries are liquid electrolytes formed by a mixture of non-aqueous organic solvents, in most cases carbonates, in which a lithium salt is dissolved.

Formulation of the electrolyte used plays an essential role as far as the performance of lithium batteries is concerned, in particular when the latter are used at very low or very high temperatures. The conductivity of the electrolyte in particular conditions the performances of the lithium battery as it acts on the mobility of the lithium ions in the electrolyte between the positive and negative electrodes.

Other parameters are also to be taken into account in the choice of the type of electrolyte used in a lithium battery. These are in particular its thermal, chemical and electrochemical stability within the battery as well as economic, safety and environment-friendly criteria including in particular the toxicity of the liquid electrolyte.

At the present time, lithium battery electrolytes operate over a small temperature range conventionally comprised between −10° C. and 50° C. without being damaged. Outside this temperature range, the electrolyte is impaired and results in a significant deterioration of the performances of the lithium battery.

Numerous works have been described to propose extending the operating range of lithium batteries, in particular by modifying the formulation of the electrolyte.

It has thus been shown that the use of solvents such as single esters, diesters or carbonates significantly improves the performances of the lithium battery at high or low temperature.

The table represented below sets out the main solvents used in lithium batteries and their physical and chemical properties.

The data set out in this table originate from the literature, in particular from the publications A. Collin, Solid State Ionics, 134, 159 (2000); Hayashi 1999: K. Hayashi, Y. Nemoto, S.-I. Tobishima, J.-I. Yamachi, Electrochimica Acta, 44, 2337 (1999); Smart 1999: M. C. Smart, B. V. Ratnakumar, S. Surampudi, J. Electrochem. Soc., 146 (2), 486 (1999) and Xu 2004: K. Xu, Chem. Rev., 104, 4303 (2004).

| | | M | Tₘ | T_{b} | T_{f} | η | | μ | ρ |
|---|---|---|---|---|---|---|---|---|---|
| Solvent | Structure | g · mol⁻¹ | (° C.) | (° C.) | (° C.) | (cP) | εᵣ | (D) | (g · cm⁻³) |
| Acetonitrile (AN) | CH₃—CN | | −45.7 | 81.8 | | 0.345 | 38.0 | 3.94 | |
| γ-butyrolactone (GBL) | | 86 | −43.5 | 204 | 97 | 1.73 | 39 | 4.23 | 1.199 |
| 1.2- Dimethylether | 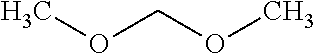 | 76 | −105 | 41 | −17 | 0.33 | 2.7 | 2.41 | 0.86 |
| 1.2- dimethoxyethane (DME) | 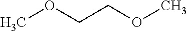 | 90 | −58 | 84 | 0 | 0.46 | 7.2 | 1.15 | 0.86 |
| Diethoxyethane (DEE) | 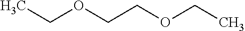 | 118 | −74 | 121 | 20 | 0.224 | 4.3 | 1.18 | 0.84 |
| Tetrahydrofurane (THF) | 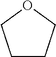 | 72 | −109 | 66 | −17 | 0.46 | 7.4 | 1.7 | 0.88 |
| 1.3-dioxalane (DL) | 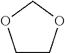 | 74 | −95 | 78 | 1 | 0.59 | 7.1 | 1.25 | 1.06 |
| Ethylene carbonate (EC) | 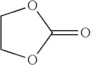 | 88 | 36.4 | 248 | 160 | 1.90 (40° C.) | 89.78 | 4.61 | 1.321 |
| Propylene carbonate (PC) | 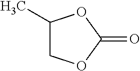 | 102 | −48.8 | 242 | 132 | 2.53 | 64.92 | 4.81 | 1.200 |
| Dimethyl carbonate (DMC) | 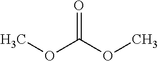 | 90 | 4.6 | 91 | 18 | 0.59 (20° C.) | 3.107 | 0.76 | 1.063 |
| Diethyl carbonate (DEC) | 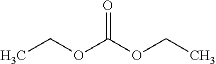 | 118 | −74.3 | 126 | 31 | 0.75 | 2.805 | 0.96 | 0.969 |
| Ethyl methyl carbonate (EMC) | 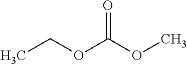 | 104 | −53 | 110 | — | 0.65 | 2.958 | 0.89 | 1.006 |

Physical and chemical properties of solvents at 25° C.,
M: molar mass in g · mo1⁻¹,
Tₘ: melting temperature,
T_{b}: boiling temperature,
T_{f}: flash temperature,
εᵣ: relative permittivity
η: dynamic viscosity,
μ: dipolar moment,
ρ: density.

Several documents of the prior art propose electrolytes composed of a mixture of organic solvents in which a lithium salt is dissolved.

In particular, the document EP-A-980108 describes an electrolyte operating at low temperature having a base formed by a quaternary mixture containing only carbonate solvents, in particular the mixture EC/DMC/EMC/DEC. The use of this electrolyte in a lithium battery enables it to be used at a temperature of less than −20° C. while at the same time maintaining good performances at ambient temperature.

Liquid electrolyte formulations used for primary lithium batteries, suitable in particular for a positive electrode made from manganese dioxide, of chemical formula MnO₂, can furthermore be found at present on the market. For example, the liquid electrolyte marketed by NOVOLYTE or SAFT or MERCK under the trade name LP40 is constituted by a lithium salt LiPF6 at a concentration of 1 mol·L⁻¹ dissolved in a binary mixture of non-aqueous organic solvents EC/DEC in a volume ratio respectively of 1/1.

### OBJECT OF THE INVENTION

The object of the invention is to propose a new liquid electrolyte that is thermally stable over a wide temperature range and the use of the latter in a lithium battery. The object of the invention is in particular to provide a new liquid electrolyte having a high ionic conductivity at both high and low temperature, and that is suitable for both primary and secondary batteries.

It is a further object of the invention to provide a liquid electrolyte that is able to activate and maintain the electrochemical properties of a lithium battery over a wide temperature range, in particular at a temperature lower than or equal to −20° C. and greater than or equal to 55° C.

This object tends to be achieved by the appended claims

### BRIEF DESCRIPTION OF THE DRAWINGS

Other advantages and features will become more clearly apparent from the following description of particular embodiments of the invention given for non-restrictive example purposes only and represented in the single appended drawing, in which:

FIG. 1 represents two plots of cycling, at a temperature of −20° C., of two LiFePO₄//C_{gr} button cells, noted A2 and B2, produced from an electrolyte solution of formulation EC/DEC/THF/EMC (1/1/1/3)+LiClO₄ 1M (A2) according to a particular embodiment of the invention and EC/DEC/THF/EMC (1/1/1/3)+LiPF₆ 1M (B2).

### DESCRIPTION OF PARTICULAR EMBODIMENTS

A liquid electrolyte for a lithium battery comprises at least one lithium salt dissolved in a quaternary mixture of non-aqueous organic solvents.

Four particular non-aqueous organic solvents, and also the nature of the lithium salt, were chosen to form the mixture of organic solvents of the liquid electrolyte for a lithium battery. What is meant by organic solvent is a non-aqueous solvent that is able to improve the ionic conduction of the electrolyte enhancing dissociation of the ions forming the lithium salt.

The lithium salt is lithium perchlorate of chemical formula LiClO₄.

The quaternary mixture of organic solvents is formed by:
ethylene carbonate, also known under the acronym EC,
diethyl carbonate, also known under the acronym DEC,
tetrahydrofurane, also known under the acronym THF and,
ethyl methyl carbonate, also known under the acronym EMC.

The organic solvents used to make the quaternary mixture of organic solvents are commercial organic solvents which can contain up to 1% of impurities. Organic solvents having a purity of more than 99.8% will nevertheless preferably be chosen.

The sum of the respective volume percentages of ethylene carbonate, diethyl carbonate, tetrahydrofurane and ethyl methyl carbonate in the mixture is equal to 100%. The quaternary mixture of organic solvents therefore advantageously does not contain any other solvent(s) than the four solvents EC, DEC, THF and EMC. More particularly, it does not contain dimethyl carbonate (DMC) as in the examples of mixtures of solvents disclosed according to the prior art.

As shown in the remainder of the description, specific selection of LiClO₄ from the group of lithium salts in combination with the quaternary mixture EC/DEC/THF/EMC induces an unexpected effect on the thermal stability, at both high and low temperature, of the liquid electrolyte used in a lithium battery.

In particular, it was surprisingly observed that the liquid electrolyte constituted solely by lithium perchlorate (LiClO₄) dissolved in the quaternary mixture has physical and chemical properties that are particularly suitable for use in a lithium battery, in particular a primary lithium battery.

According to a particular embodiment of the invention, the quaternary mixture of organic solvents preferably contains between:
0.5% and 33% by mass of ethylene carbonate (EC),
0.5% and 33% by mass of diethyl carbonate (DEC),
0.5% and 33% by mass of tetrahydrofurane (THF) and,
1.5% and 98.5% by mass of ethyl methyl carbonate (EMC).

The quaternary mixture preferably contains at least 5% by mass of each of the organic solvents.

According to a particular embodiment of the invention, the quaternary mixture of organic solvents preferably contains between:
10% and 30% by mass of ethylene carbonate (EC),
10% and 30% by mass of diethyl carbonate (DEC),
10% and 30% by mass of tetrahydrofurane (THF) and,
10% and 70% by mass of ethyl methyl carbonate (EMC).

According to a preferred particular embodiment, the quaternary mixture is an ethylene carbonate/diethyl carbonate/tetrahydrofurane/ethyl methyl carbonate mixture, noted EC/DEC/THF/EMC, in a mass ratio respectively of 1/1/1/3. What is meant by 1/1/1/3 mass ratio is a quaternary mixture of non-aqueous organic solvents that contains 50/3% by mass of propylene carbonate, 50/3% by mass of diethyl carbonate, and 50/3% by mass of tetrahydrofurane and 50% by mass of ethyl methyl carbonate.

The mass ratio of each organic solvent in the quaternary mixture enables the ionic conduction and solvatation properties of the lithium salt and the resistance of the liquid electrolyte to be improved over a large temperature range, in particular for a temperature range comprised between −20° C. and 55° C.

In order to obtain an optimal dissociation of the ions constituting the LiClO₄ salt in the quaternary mixture of organic solvents described above thereby enhancing transfer of the Li⁺ cation, a LiClO₄ lithium salt concentration is advantageously chosen comprised between 0.1 mol·L⁻¹ and 6 mol·L⁻¹, and preferably equal to 1 mol·L⁻¹±0.2.

The particular formulation of the liquid electrolyte as described above presents physical and chemical properties that are particularly suitable for use in a lithium battery.

The liquid electrolyte is advantageously used for a lithium battery able to operate in a temperature range comprised between −20° C. and 55° C.

According to a particular embodiment of the invention, the liquid electrolyte is particularly suitable for a lithium battery comprising:
a positive electrode comprising a positive active material,
a negative electrode comprising a negative active material,
and a separator arranged between the positive and negative electrodes and imbibed with the electrolyte.

The liquid electrolyte can be used in a primary lithium battery. The negative active material is metal lithium and the positive active material is advantageously chosen from MnO₂ and NiO₂. The positive active material is preferably MnO₂.

Alternatively, the liquid electrolyte can be used in a secondary lithium battery. For a secondary lithium battery, a negative active material will preferably be chosen from carbon graphite (C_{gr}), Li₄Ti₅O₁₂, silicon and silicon carbide.

Likewise, the positive active material is advantageously chosen from LiFePO₄, LiNi_{0.33}Mn_{0.33}Co_{0.33}O₂, LiNiₓCo_{y}Al_{z}O₂ with the sum of the values of x, y and z being equal to 1, LiMnO₂, LiNiO₂ and LiNiₓMn_{y}O₄ with x comprised between 0.4 and 0.5 and y comprised between 1.5 and 1.6.

According to a preferred particular embodiment, for a secondary lithium battery, the positive active material is LiFePO₄ and the negative active material is carbon graphite (C_{gr}).

The separator can conventionally be a porous membrane made from composite or ceramic, or a microporous membrane made from polymer, for example a polyolefin-based polymer. The separator can also be formed by non-woven glass fibres sunk in a polymer to improve their very low mechanical stability.

The separator is impregnated by the liquid electrolyte as described in the foregoing.

The liquid electrolyte enables a lithium battery to be produced delivering a high power at high current charge-discharge rates, while at the same time having a low self-discharge over a large temperature range, in particular for extremely low and extremely high temperatures. The lithium battery made from the liquid electrolyte according to the invention can thus operate over a large temperature range, preferably comprised between −20° C. and +55° C., and more advantageously between −40° C. and +60° C. What is meant by self-discharge is the ability of a battery placed in a charged state to discharge, even when it is not used or “on the shelf”.

In order to highlight the effect of the lithium salt LiClO₄ on the electric performances of a lithium battery, a series of electrochemical tests were performed on two primary lithium batteries MnO₂//Liₘₑₜ which differ solely by the nature of the lithium salt used in the liquid electrolyte (comparative examples 1). Likewise, a series of electrochemical tests were performed on two secondary lithium batteries LiFePO₄//C_{gr} which differ solely by the nature of the lithium salt used in the liquid electrolyte (comparative examples 2).

### COMPARATIVE EXAMPLES 1

A primary lithium battery, noted A1, of button cell type is produced from the couple of active materials MnO₂//Li_{met.} respectively corresponding to the positive electrode and the negative electrode.

In particular, a MnO₂ positive electrode is formed by depositing the following mixture on an aluminium current collector:
94% by mass of MnO₂ active material,
5% by mass of SFG6 graphite marketed by Timcal as electron conducting material and,
1% by mass of polytetrafluoroethylene (PTFE) with 60% by mass in water as binder.

The liquid electrolyte is constituted by LiClO₄ dissolved in a binary mixture of LP40 organic solvents marketed by Merck. The binary mixture, noted mₐ₁, is a EC/DEC mixture with a volume ratio 1/1. The quantity of LiClO₄ added in the binary mixture is adjusted to obtain a liquid electrolyte solution with a LiClO₄ concentration of 1 mol·L⁻¹.

A separator of Celgard 2400® type is imbibed by the liquid electrolyte formed in this way and placed between the positive and negative electrodes, respectively MnO₂//Liₘₑₜ.

For comparison purposes, a lithium battery called B1 was also produced and differs from lithium battery A1 solely by the fact that the LiClO₄ lithium salt is replaced by LiPF6.

A series of cycling tests on a BT200 model ARBIN bench provided by ARBIN Instruments were performed at ambient temperature on each lithium battery A1 and B1, in discharge at C/50 and C/100 discharge rate.

The results of lithium batteries A1 and B1 are set out in the following table 1:

TABLE 1

| | C50 Discharge rate | | C100 Discharge rate | |
|---|---|---|---|---|
| | Discharge | Discharge capacity/ | Discharge | Discharge capacity/ |
| | capacity | theoretical capacity | capacity | theoretical capacity |
| Ref. | (Ah · g⁻¹) | (in %) | (Ah · g⁻¹) | (in %) |
| A1 | 0.144 | 96 | 0.148 | 98.6 |
| B1 | 0.052 | 34.6 | 0.08 | 53 |

The results clearly show better results for the lithium battery A1 as compared with B1.

### COMPARATIVE EXAMPLES 2

A lithium battery, noted A2, of button cell type is produced from the couple of active materials LiFePO₄//C_{gr} respectively corresponding to the positive electrode and the negative electrode.

In particular, a LiFePO₄ positive electrode is formed by depositing the following mixture on an aluminium current collector:
90% by mass of LiFePO₄ active material,
4% by mass of carbon black used as conducting material and,
6% by mass of polyvinylidene fluoride (PVdF) as binder.

In particular a negative electrode C_{gr} is formed by depositing the following mixture on a copper current collector:
96% by mass of active material formed by 75% of carbon graphite material, 19-20% of fibres (tenax) and 6-5% of carbon black,
2% by mass of carboxymethylcellulose used as electrode thickener and binder and,
2% by mass of nitrile butadiene rubber (N BR) used as elastomer.

The liquid electrolyte is formed by LiClO₄ lithium salt dissolved in a quaternary mixture of organic solvents, noted mₐ₂, constituted by the non-aqueous organic solvents EC/DEC/THF/EMC in a mass ratio of 1/1/1/3. The quantity of LiClO₄ added in the binary mixture is adjusted to obtain a liquid electrolyte solution with a LiClO₄ concentration of 1 mol·L⁻¹.

A Celgard 2400® separator is imbibed by the liquid electrolyte thus formed and placed between the positive and negative electrodes, respectively LiFePO₄//C_{gr}.

For comparison purposes a lithium battery called B2 was also produced and differs from lithium battery A2 solely by the fact that the LiClO₄ lithium salt is replaced by LiPF6.

A series of cycling tests on a BT200 model ARBIN bench from ARBIN Instruments were performed at a temperature of −20° C. on each lithium battery A2 and B2, according to the following cycling protocol:
2 formation cycles at C/20-D/20 charge-discharge rate at ambient temperature,
5 charge and discharge cycles at C/20-D/20 rate at −20° C.,
100 charge and discharge cycles at C/10-D/10 rate at −20° C.

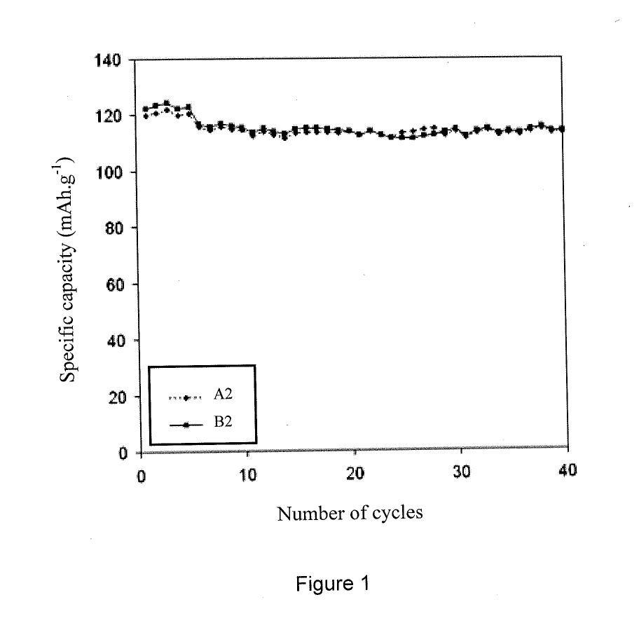

The results are represented in FIG. 1 in the form of a graph representing the specific capacity versus the number of cycles.

As represented in FIG. 1, it can be observed that the results obtained for A2 and B2 are comparable with the mean recovered specific capacities of 113 mAh·g⁻¹ and 114 mAh·g⁻¹, respectively for LiClO₄ and LiPF₆. Compared with the theoretic specific capacity of the LiFePO₄ material, a value is obtained that corresponds to 80.7% for LiClO₄ and 81.4% for LiPF₆ of restored capacity, at a temperature of −20° C., at a C/10-D/10 charge-discharge rate. Lithium battery A2 operates as well as lithium battery B2 at a very low temperature of −20° C. The results obtained confirm that the liquid electrolyte can be used for a secondary lithium battery at low temperature of about −20° C., or even very low temperature of about −40° C. to −60° C.

In order to highlight the effect of the formulation of the quaternary mixture of organic solvents of the liquid electrolyte according to the invention on the electric performances and the thermal stability of lithium batteries, other series of tests were also performed with different formulations under identical conditions.

Primary lithium batteries MnO₂//Li_{met.}, noted A3, B3 and B4, were produced from three mixtures of different non-aqueous organic solvents, noted m_{A3}, m_{B3} and m_{B4}. With the exception of the mixture of organic solvents constituting the liquid electrolyte, lithium batteries A3, B3 and B4 are identical and were produced using the same operating mode as lithium battery A1 described in the foregoing.

The formulations of the three mixtures of organic solvents m_{A3}, m_{B3} and m_{B4} are set out in the following table 2:

TABLE 2

| Lithium | | Organic solvents | Mass ratio of the |
|---|---|---|---|
| battery | Mixture | of the mixture | solvents |
| A3 | m_{A3} | EC/DEC/THF/EMC | 1/1/1/3 |
| B3 | m_{B3} | PC/DEE/THF | 1/1/1 |
| B4 | m_{B4} | PC/DME | 1/1 |

A series of tests on discharge at C50 and C100 rates were performed on each lithium battery A3, B3 and B4, at temperatures of −20° C., −15° C., 37° C. and 55° C.

The means of the specific capacities recovered on discharge, noted C_{d}, and the values of the ratio R corresponding to the specific discharge capacity over the expected theoretical capacity, noted C_{T}, were evaluated at different temperatures.

If at high temperature (37° C. and 55° C.), batteries A3, B3 and B4 supply an identical specific capacity that is about the same as the expected theoretical capacity, the same is not the case at low temperature.

As illustrated by the results set out in tables 3 and 4 below, battery A3 effectively prevents better results at −20° C. and at −15° C.

TABLE 3
Temperature of −20° C.

C100 discharge rate

| | C_{d} | C_{d}/C_{T} |
|---|---|---|
| Reference | (Ah · g⁻¹) | (in %) (in %) |
| A3 | 59.1 | 39.4 |
| B3 | 37.8 | 25.2 |
| B4 | 0 | 0 |

TABLE 4
Temperature of −15° C.

C100 discharge rate

| | C_{d} | C_{d}/C_{T} |
|---|---|---|
| Reference | (Ah · g⁻¹) | (in %) (in %) |
| A3 | 75 | 50 |
| B3 | 67 | 44.6 |
| B4 | 0 | 0 |

The use of the mixture m_{A3} surprisingly enables appreciably higher recovered specific capacities to be obtained at low temperature than the other two mixtures m_{B3} and m_{B4}.

The liquid electrolyte according to the invention presents good physical and chemical properties over a wide temperature range making it particularly interesting for use in a lithium battery.

The lithium battery comprising an electrolyte according to the invention is remarkable in that it presents an improved resistance at low temperature while at the same time preserving a high specific capacity at high temperature.

Furthermore, the liquid electrolyte according to the invention is industrially interesting as it can be used for both primary and secondary lithium batteries.

1. A liquid electrolyte for a lithium battery comprising a lithium salt dissolved in a quaternary mixture of non-aqueous organic solvents, wherein the lithium salt is lithium perchlorate (LiClO₄) and in that the quaternary mixture is constituted by ethylene carbonate (EC), diethyl carbonate (DEC), tetrahydrofurane (THF) and ethyl methyl carbonate (EMC).

2. The electrolyte according to claim 1, is said electrolyte being constituted by lithium perchlorate (LiClO₄) dissolved in the quaternary mixture of non-aqueous organic solvents.

3. The electrolyte according to claim 1, the quaternary mixture contains at least 5% by mass of each of the organic solvents.

4. The electrolyte according to claim 3, said electrolyte containing between:
10% and 30% by mass of ethylene carbonate (EC),
10% and 30% by mass of diethyl carbonate (DEC),
10% and 30% by mass of tetrahydrofurane (THF) and,
10% and 70% by mass of ethyl methyl carbonate (EMC).

5. The electrolyte according to claim 1, wherein the quaternary mixture of non-aqueous onganic solvents is an ethylene carbonate/diethyl carbonate/tetrahydrofurane/ethyl methyl carbonate (EC/DEC/THF/EMC) mixture, in a mass ratio respectively of 1/1/1/3.

6. The electrolyte according to claim 1, wherein the concentration of LiClO₄ lithium salt is comprised between 0.1 mol·L⁻¹ and 6 mol·L⁻¹.

7. A lithium battery comprising a liquid electrolyte according to claim 1.

8. A lithium battery according to claim 7, said lithium battery comprises:
a positive electrode comprising a positive active material,
a negative electrode comprising a negative active material,
and a separator arranged between the positive and negative electrodes and imbibed with the electrolyte.

9. A lithium battery according to claim 8, wherein the negative active material is metal lithium.

10. A lithium battery according to claim 9, wherein the positive active material is chosen from MnO₂ and NiO₂.

11. A lithium battery according to claim 10, wherein the positive active material is MnO₂.

12. A lithium battery according to claim 8, wherein the negative active material is chosen from carbon graphite (C_{gr}), Li₄Ti₅O₁₂, silicon and silicon carbide.

13. A battery according to claim 12, wherein the positive active material is chosen from LiFePO₄, LiNi_{0.33}Mn_{0.33}Co_{0.33}O₂, LiNiₓCo_{y}Al_{z}O₂ with the sum of the values of x, y and z being equal to 1, LiMnO₂, LiNiO₂ and LiNiₓMn_{y}O₄ with x comprised between 0.4 and 0.5 and y comprised between 1.5 and 1.6.

14. A lithium battery according to claim 12, wherein the positive active material is LiFePO₄ and the negative active material is carbon graphite (C_{gr}).

15. The electrolyte according to claim 1, wherein the concentration of LiClO₄ lithium salt is equal to 1 mol·L⁻¹±0.2.
